(19) United States
(12) Patent Application Publication
(10) Pub. No.: US 2010/0189476 A1
(43) Pub. Date: Jul. 29, 2010

(54) IMAGE FORMING DEVICE AND IMAGE FORMING METHOD

(75) Inventors: Shinichi TANAKA, Shiojiri-shi (JP); Ken IKUMA, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/691,903

(22) Filed: Jan. 22, 2010

(30) Foreign Application Priority Data
Jan. 26, 2009 (JP) 2009-014040

(51) Int. Cl. G03G 15/16

(52) U.S. Cl. 399/313

(57) ABSTRACT

An image forming device including a first image carrier; a first development unit that develops the first image carrier with a first liquid developer; a second image carrier; a second development unit that develops the second image carrier with a second liquid developer; a transfer belt to which the images developed on the first image carrier and the second image carrier are transferred; and a transfer roller which has a transfer material gripping member for gripping a transfer material, is brought into pressure contact with the transfer belt and is applied with a transfer bias so as to transfer the images which has been transferred to the transfer belt to the transfer material, wherein the transfer material gripping member is positioned inside of the outer periphery surface of the transfer roller so as to grip the transfer material.

### BACKGROUND

1. Technical Field

The present invention relates to an electro-photographic type image forming device and image forming method using a liquid developer including a solid particle toner and a carrier liquid.

2. Related Art

In a wet type image forming device using a liquid developer, since the transfer surface of the toner image side of the transfer material such as a paper is brought into pressure contact with a middle transfer medium, after transfer the transfer material is likely to adhere to the middle medium. Therefore, in the past, there has been provided an image forming device in which an air is blown into a front end of a transfer material after transfer so as to peel the transfer material off the transfer roller (for example, see Japanese Patent No. 3128067). However, in the image forming device described in the patent publication, since the air is merely blown into the front end of the transfer material, it is difficult to reliably peel off the transfer material.

On the other hand, in an image forming device using a dry type developer, there has been proposed an image forming device in which a toner image of a photosensitive body is transferred onto a transfer material in a state in which the front end of the transfer material is gripped by a gripper of a transfer drum (for example, see JP-A-3-4241). As described above, transfer is performed in a state in which the front end of the transfer material is gripped, so that it is possible to peel the transfer material off the photosensitive body after transfer.

Furthermore, in a stencil printing device, there has been proposed a stencil printing device in which an ink image of a plate body is stencil-printed on a transfer material in a state in which a front end of the transfer material is clamped by a clamp of a pressure body to be pressure-contacted with the plate body (for example, see JP-A-2000-238400). As describe above, printing is performed in a state in which the front end of the transfer material is clamped, so that it is possible to peel the transfer material off the plate body after printing.

Incidentally, in a wet type image forming device of related art, there is a wet type image forming device which performs a transfer by the use of a transfer belt formed of an elastic belt and a transfer roller. If the technique of peeling the front end of the transfer material described in Japanese Patent No. 3128067 is applied to this wet type image forming device, there is a problem in which it is more difficult for the transfer belt to peel the transfer material than the transfer roller. Therefore, it is considered that the technique of peeling the front end of the transfer material using the grip described in JP-A-3-4241 or the clamp described in JP-A-2000-238400 is applicable to the wet type image forming device having the transfer belt and the transfer roller. However, the transfer material gripping member such as the gripper described in JP-A-3-4241 or the clamp described in JP-A-2000-238400 protrudes from the outer periphery surface of the transfer drum or the outer periphery surface of the pressure body in a state in which the transfer material is gripped or clamped. For this reason, when the transfer material gripping member approaches a nip portion between the photosensitive body and the transfer drum or a nip portion between the plate body and the pressure body, there is a problem in which the rotation of the transfer drum or the pressure plate is disturbed or the pressure-contact force is fluctuated to generate bending, whereby it is difficult to perform an excellent image formation. Moreover, since the transfer belt is relatively resilient, the transfer material gripping member protruded from the outer periphery surface of the transfer roller may damage the transfer belt at the time of transfer, therefore the durability of the transfer belt becomes a problem. Thus, it is difficult to simply apply the technique of peeling the front end of the transfer material described in JP-A-3-4241 or JP-A-2000-238400 to the image forming device having the transfer belt.

### SUMMARY

An advantage of some aspects of the invention is to provide an image forming device and an image forming method which are capable of performing more excellent image forming while securely performing the peeling of the transfer material from the transfer belt after transferring even when using a liquid developer and are further capable of improving the durability of the transfer belt.

In the image forming device according to one embodiment of the invention, while a transfer material gripping member is positioned inside of an outer periphery surface of a transfer roller to grip a transfer material, a third image of a liquid developer transferred to a transfer belt is transferred to the transfer material. Therefore, after transferring, it is possible to more securely peel the transfer material off the transfer belt.

In addition, since the transfer material gripping member is positioned inside of the outer periphery surface of the transfer roller to grip the transfer material, when the transfer material gripping member passes a transfer nip between the transfer belt and the transfer roller, disturbance of each rotation of the transfer belt and the transfer roller can be suppressed, and at the same time the fluctuation in the pressure-contact force of the transfer belt and the transfer roller can be suppressed. Thus, bending hardly occurs and it is possible to perform the excellent image forming. In addition, since the transfer material gripping member does not protrude from the outer periphery surface of the transfer roller, damage of the transfer belt due to the transfer material gripping member can be suppressed. As a result, even if the transfer material gripping member is installed at the transfer roller, the durability of the transfer belt can be improved.

Furthermore, transfer to the transfer material is performed while gripping the front end of the transfer material by a first member, and at the same time at the time of release of the gripping of the front end of the transfer material by use of the first member, the transfer member is separated from the transfer roller by use of a second member. In this way, by using two first and second members having different functions as the transfer material gripping member, the peeling of the transfer material from the transfer belt can be securely performed, and at the same time it is possible to excellently transport the transfer material from the transfer roller to the next processing unit.

In addition, the rotation radius around the rotation center of the transfer roller of the second member at the time of separating the transfer material from the transfer roller is made to be larger than the rotation radius around the rotation center of the transfer roller of the first member at the time of release of the gripping of the front end of the transfer material. As a result, it is possible to more satisfactorily transport the transfer material after gripping release to the next processing unit.

In that case, by separately forming the first member and the second member, it is possible to independently and flexibly control the first member and the second member.

Furthermore, by integrally forming the first and second members, it is possible to simultaneously control the first and second members and structures of control units of the first and second members become simple.

In addition, since the contact portion of the second member with the transfer belt is formed in a curved shape, for example, by loosing the belt tension by a belt tension release unit, even if the transfer belt is bent and contacts the contact portion of the second member, it is possible to effectively suppress damage to the transfer belt due to the second member.

In addition, by fixing a fourth image of the transfer material after transfer with a fixing portion, even if the gripping portion of the transfer material is slightly collapsed by the transfer material gripping member, it is possible to correct the collapse of the transfer material to some extent by heating and pressurization of the fixing portion.

In addition, the transfer material is separated from the transfer belt, while transferring a third image of the transfer belt to the transfer material. As a result, it is possible to reduce the image forming time.

### BRIEF DESCRIPTION OF THE DRAWINGS

The invention will be described with reference to the accompanying drawings, wherein like numbers reference like elements.

FIG. 1 is a diagram showing schematically and partly one embodiment of an image forming device according to the invention.

FIG. 2A is a partly perspective view showing of a second transfer portion of the image forming device of the example shown in FIG. 1.

FIG. 2B is an enlarged view of part IIB in FIG. 2A.

FIG. 2C is a part right side view of FIG. 2A.

FIG. 3A is a right side view showing one example of a gripper.

FIG. 3B is a right side view showing a modification example of the gripper.

FIG. 3C is a right side view showing another modification example of the gripper.

FIG. 3D is a right side view showing still another modification example of the gripper.

FIG. 4A is a diagram showing the gripper in a gripping position.

FIG. 4B is a diagram showing the gripper in a release position.

FIG. 5A is a diagram showing a protruding hook in a retracted position.

FIG. 5B is a diagram showing the protruding hook in a protruding position.

FIG. 6A is a diagram showing the state in which gripper in the gripping position and the protruding hook in the retracted position are positioned inside of an outside line of the second transfer roller.

FIG. 6B is a diagram showing the state in which gripper in the release position and the protruding hook in the protruding position are positioned outside of an outside line of the second transfer roller.

FIG. 7A is a part right side view showing one example of the protruding hook in part.

FIG. 7B is a part right side view showing another example of the protruding hook in part.

FIG. 7C is a part right side view showing still another example of the protruding hook in part.

FIG. 8 is a diagram illustrating the gripping of the front end of the transfer material by use of the gripper at the time of transfer.

FIG. 9 is a diagram showing the gripper in the release position and the protruding hook in the protruding position.

FIG. 10 is a diagram illustrating the peeling and the guide of the transfer material after transfer.

FIG. 11 is a partly enlarged view that partly shows another example of the embodiment of the image forming device of the invention.

### DESCRIPTION OF EXEMPLARY EMBODIMENTS

Hereinafter, the embodiments of the invention will be described with reference to the drawings.

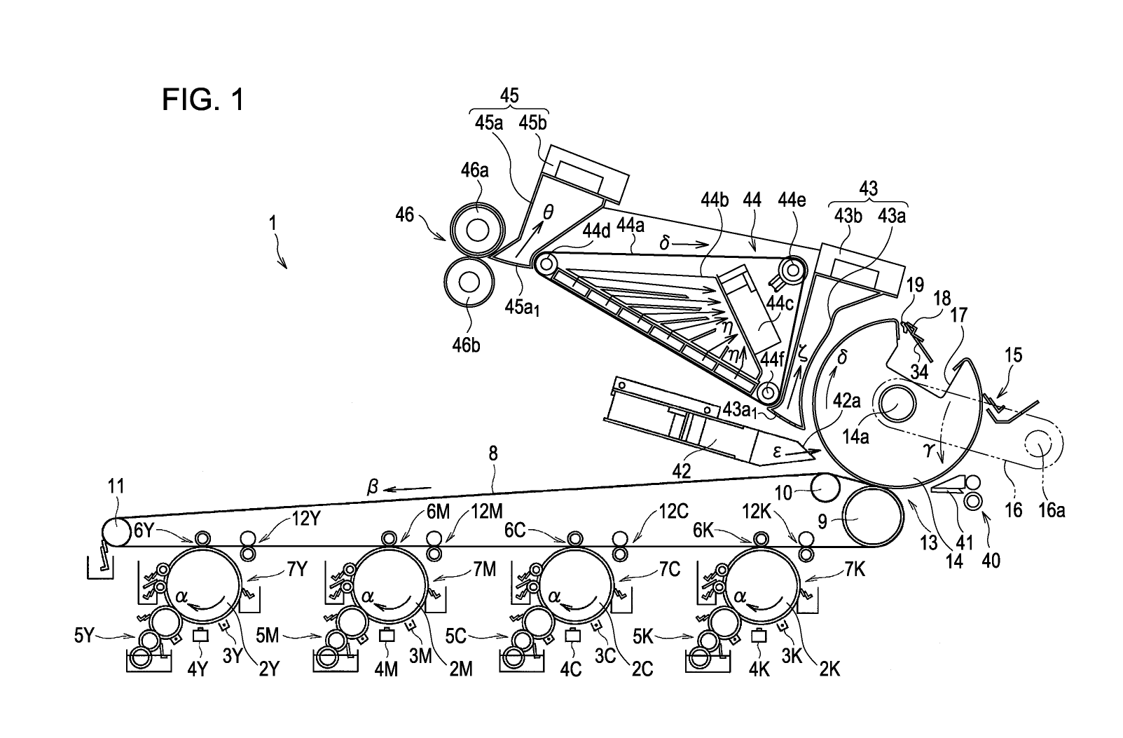

FIG. 1 schematically and partly shows one portion of one example of the embodiment of the image forming device according to the invention.

As shown in FIG. 1, an image forming device 1 of this example performs the image forming by using a liquid developer including a solid particle toner and a carrier liquid. The image forming device 1 includes photosensitive bodies 2Y, 2M, 2C and 2K which are first to fourth image carriers of a yellow (Y), a magenta (M), a cyan (C) and a black (K) arranged in tandem. Herein, in each of the photosensitive bodies 2Y, 2M, 2C and 2K, 2Y represents a yellow photosensitive body, 2M represents a magenta photosensitive body, 2C represents a cyan photosensitive body and 2K represents a black photosensitive body. In addition, similarly, also in the other members, Y, M, C and K of each color are also added to the symbols of the members to represent each color member.

Electrification portions 3Y, 3M, 3C and 3K are installed around each photosensitive body 2Y, 2M, 2C and 2K, respectively. In addition, from each electrification portion 3Y, 3M, 3C and 3K toward the rotation direction a of each photosensitive body 2Y, 2M, 2C and 2K, light exposure portions 4Y, 4M, 4C and 4K, development portions 5Y, 5M, 5C and 5K being first to fourth development portions, first transfer portions 6Y, 6M, 6C and 6K and photosensitive body cleaning portions 7Y, 7M, 7C and 7K are arranged in this order.

In addition, the image forming device 1 includes an endless type middle transfer belt 8 being the transfer belt. This middle transfer belt 8 is formed of a relatively resilient elastic belt of three-layers structure that has, although not shown, a flexible base material such as a resin, an elastic layer such as a rubber formed on the surface of the base material and a surface layer formed on the surface of the elastic layer, for example. Of course, it is not limited thereto. Furthermore, the middle transfer belt 8 is wound around a middle transfer belt drive roller 9 to which the driving force of a motor (not shown) is transmitted, a winding roller 10 and a middle transfer belt tension roller 11. In that case, the middle transfer belt tension roller 11 is configured as the tension roller. Thus, the middle transfer belt 8 is tensioned by the tension roller and at the same time the tension by the tension roller is released. The tension release of this middle transfer belt 8 is executed by controlling the middle transfer belt tension roller 11 with a belt tension release portion (not shown). Furthermore, the middle transfer belt 8 is configured so as to be rotated in a direction β (counterclockwise in FIG. 1) indicated by an arrow. In addition, arrangement order of the members such as the photosensitive bodies corresponding to each color Y, M, C and K is not limited to the example shown in FIG. 1 but can be voluntarily set.

In the positions the middle transfer belt 8 in vicinity of each of the first transfer portions 6Y, 6M, 6C and 6K which have been progressed in the rotation direction of the middle transfer belt 8 further than each first transfer portion 6Y, 6M, 6C and 6K, middle transfer belt squeeze devices 12Y, 12M, 12C and 12K are disposed, respectively. In addition, in the middle transfer belt drive roller 9 of the middle transfer belt 8, a second transfer portion 13 is disposed.

The second transfer portion 13 includes a second transfer roller 14 and a second transfer roller cleaning portion 15. The second transfer roller 14 has an elastic member 14c such as a rubber sheet which is wrapped around the outer peripheral surface of the arc portion of the base material 14b. Furthermore, the elastic member 14c may be adhered to the outer peripheral surface of the arc portion of the base material 14b. A resistance layer is formed on the outer peripheral surface of the arc portion of the second transfer roller 14 by the elastic member 14c, and at the same time, the second transfer roller 14 is formed of the elastic roller. A rotation axis 14a of the second transfer roller 14 is rotatably supported to an arm 16. The arm 16 is rotationally oscillated about the rotation axis 16a supported to a device main body (not shown) and at the same time is pressurized in a direction γ indicated by an arrow (counterclockwise in FIG. 1) by means of a spring (not shown). By means of the pressurization force of the spring, the second transfer roller 14 brings the middle transfer belt 8 into pressure-contact with the middle transfer belt drive roller 9.

Furthermore, by means of the winding roller 10, the middle transfer roller 8 is partly wound around the second transfer roller 14. Thus, a transfer nip of the middle transfer belt 8 and the second transfer roller 14 includes a pressurization nip that is generated by pressurizing the middle transfer belt 8 to the drive roller 9 by the second transfer roller 14 and a winding nip that is generated by winding the middle transfer belt 8 around the second transfer roller 14. That is to say, the transfer nip of the middle transfer belt 8 and the second transfer roller 14 is configured as the long nip compared to only the pressurization nip. In that case, the second transfer roller 14 is installed at the winding end side of drive roller 9 of the middle transfer belt 8, so that the transfer nip is set at the middle transfer belt tension roller 11 side than the center of the rotation axis 14a of the second transfer roller 14 at the lower side than the center of the rotation axis 14a of the second transfer roller 14. In addition, the second transfer roller 14 is applied with a transfer bias by which the toner image transferred to the middle transfer belt 8 is transferred to the transfer material.

Furthermore, the second transfer roller 14 rotates in the direction δ indicated by the arrow according to the rotation in the direction β of the middle transfer belt 8 and at the same time is applied with the transfer bias, thereby transferring the toner image of the middle transfer belt 8 to the transfer material in the transfer nip.

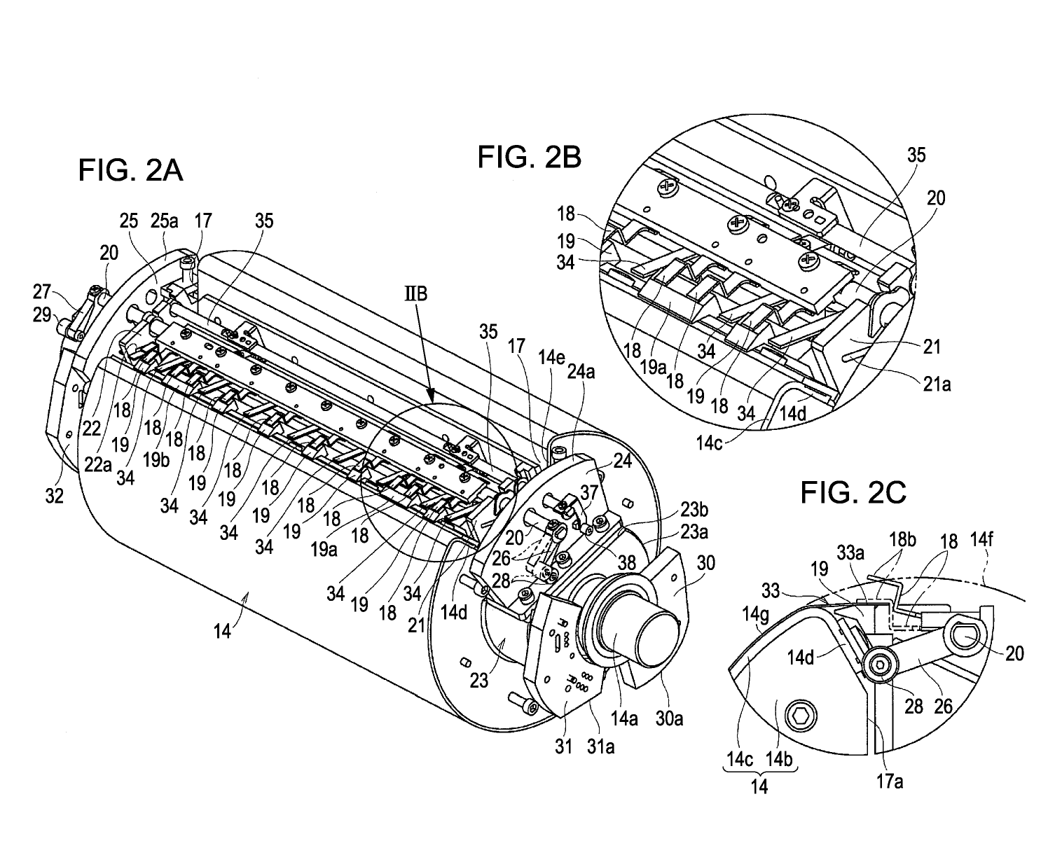

Further, the second transfer roller 14 has a concave portion 17 being the transfer material gripping member receiving portion. As shown in FIG. 2A, the concave portion 17 extends in the axial direction of the second transfer roller 14. Both ends 14d and 14e of the elastic member 14c are installed on the wall surface in the concave portion formed in the base material 14b. Thus, the concave portion 17 of the second transfer roller 14 is formed by the concave portion of the base material 14b and the both ends 14d and 14e of the rubber sheet 14c.

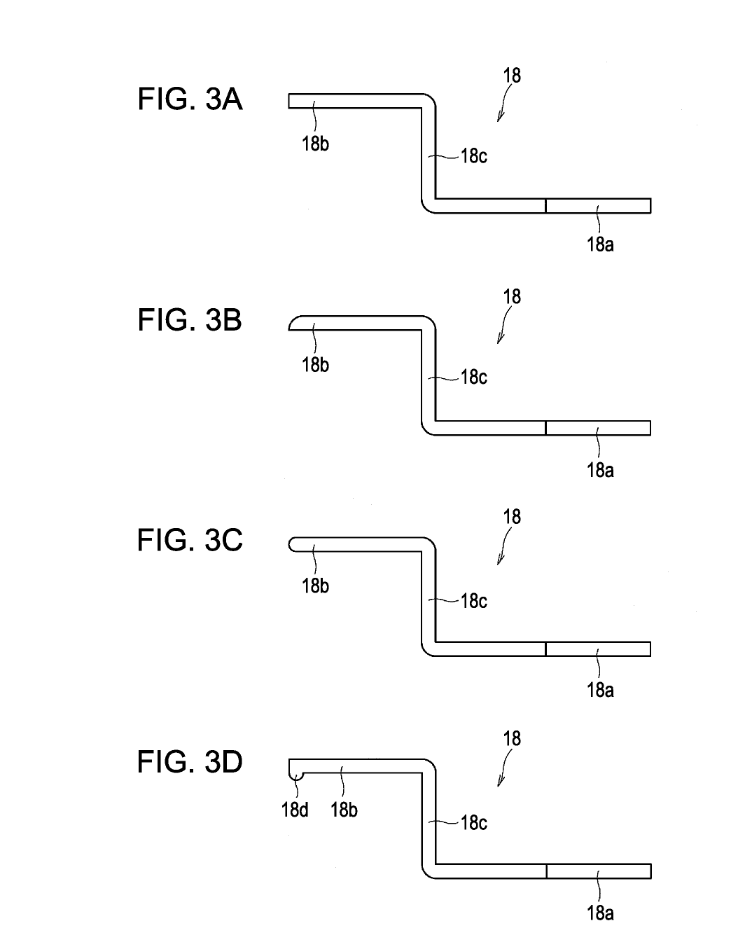

Further, in the concave portion 17, a gripper 18 as the transfer material gripping member being a first member of the invention and a gripper supporting member 19 being a transfer material gripping member receiving member on which the gripper 18 sits are arranged. As shown in FIGS. 2A and 2B, ten grippers 18 are disposed along the axial direction of the second transfer roller 14. Of course, the number of grippers 18 is not limited to ten, but any number thereof can be installed. Each gripper 18 is formed in the same shape and the same size from the metallic thin band-shaped plate. As an on example, as shown in FIG. 3A, the gripper 18 is formed so as to be bent in a crank shape. In that case, one end of the gripper 18 (right end portion in FIG. 3A) is a fixed end 18a that is fixed to the rotation axis 20, and the other end of the gripper 18 (left end portion in FIG. 3A) is a gripping portion 18b which sits on and stands from the gripper supporting member 19. This gripping portion 18b interposes a front end 35a of the transfer material 35 between with the gripper supporting member 19 so as to grip. In addition, the gripper 18 has a step portion 18c that is formed between the fixed end 18a and the gripping portion 18b.

Furthermore, as another example, as shown in FIG. 3B, in the gripper 18, the front end upper side edge portion of the gripping portion 18b is formed in the curved portion such as R portion. In addition, as another example, as shown in FIG. 3C, in the gripper 18, the front end of the gripping portion 18b is formed in the curved portion such as the arced portion. Furthermore, as another example, as shown in FIG. 3D, the gripper 18 has a protruding portion 18d which protrudes from the front end of the gripping portion 18b and at the same time sits on and stands from the gripper supporting member 19. The front end of the protruding portion 18d is formed on the curved surface such as the arced surface and at the same time interposes the front end 35a of the transfer material 35 between with the gripper supporting member 19 so as to grip the front end. Other construction of the gripper 18 shown in FIGS. 3B to 3D is identical to that of the gripper 18 shown in FIG. 3A.

Each gripper 18 is installed at the rotation axis 20 so as to be rotated integrally with the rotation axis 20. Both ends of the rotation axis 20 are supported so as to be rotated relative to support plates 21 and 22 installed vertically in the position opposite to the concave portion 17 of the second transfer roller 14. As shown in FIGS. 2A to 2C, both ends of the rotation axis 20 pass through the support plates 21 and 22 to extend in the rotation direction of the second transfer roller 14.

Incidentally, the periphery length of the second transfer roller 14 is set to be larger than the length of the transfer material movement direction of the transfer material 33 in which the length of the transfer material movement direction is maximum in the type of the transfer material 33 used in the image forming device 1 of this example. More specifically, the periphery length of the second transfer roller 14 excepting the rotation direction width of the second transfer roller of the concave portion 17 is set to be larger than the maximum length of the transfer material movement direction of the transfer material 33 described above. As a result, the toner image of the middle transfer belt 8 is also securely transferred to the transfer material 33 having the maximum length of the transfer material movement direction described above.

Furthermore, as shown in FIG. 2A, in one end of the second transfer roller 14, there is installed a contact member support portion 23 so as to be rotated integrally with the second transfer roller 14. This contact member support portion 23 has an arced portion 23a and a flat support surface 23b formed in a chord shape. The arced portion 23a is formed in the arc which is concentric with the circle of the arced outer peripheral surface of the second transfer roller 14. In addition, in the support surface 23b, the center of the support surface 23b in the direction perpendicular to the axial direction of the second transfer roller 14 corresponds to the center of the concave portion 17 in the circumferential direction of the second transfer roller 14 or nearly corresponds thereto. Furthermore, the length of the support surface 23b in the direction perpendicular to the axial direction of the second transfer roller 14 is set to be larger than the length (width) of the concave portion 17 in the circumferential direction of the second transfer roller 14. While it is not shown, also in the other end of the second transfer roller 14, the contact member support portion identical to the contact member support portion 23 is also installed similarly to the contact member support portion 23. This contact member support portion 23 is also formed exactly in the same shape and size with the contact member support portion 23. Furthermore, contact member support portion is installed at a line symmetrical manner to the straight line of the direction perpendicular to the axial direction of the second transfer roller 14.

Further, a transfer bearer 24 being a contact member is installed vertically on the support surface 23b. Similarly, the identical transfer bearer 25 is also vertically installed on the support surface 23b of the contact support member of the other end of the second transfer roller 14. In that case, each of the transfer bearers 24 and 25 rotates integrally with the second transfer roller 14. These transfer beatings 24 and 25 have arced outer peripheral surfaces 24a and 25a that are concentric with the circle of the arced outer peripheral surface 14g of the second transfer roller 14. These transfer bearers 24 and 25 come in direct or indirect contact with the rotation axis of the middle transfer belt drive roller 9, when the concaves 17 thereof are opposed to the position (position of the pressurization nip with the middle transfer belt 8) opposite to the middle transfer belt drive roller 9. As a result, the relative position of the second transfer roller 14 to the drive roller 9 is maintained nearly the same as the relative position of the second transfer roller 14 and the drive roller 9 in a state in which the arced outer peripheral surface 14g of the second transfer roller 14 is in contact with the middle transfer belt 8.

Each end of the rotation axis 20 passed through the support plates 21 and 22 passes through so as to relatively rotate the transfer bearers 24 and 25. On both ends of the rotation axis 20 passed through the transfer bearers 24 and 25, one ends of the first arm 26 and the second arm 27 are installed so as to be rotated integrally with the rotation axis 20. The first and second arms 26 and 27 are always pressurized in the direction (counterclockwise in FIG. 2C) in which the gripper 18 sits on the gripper support member 19 by a spring (not shown). On the other ends of the first and second arms 26 and 27, a roller-shaped first gripper control cam follower 28 and a roller-shaped second gripper control cam follower 29 are installed so as to be rotated relatively with the first and second arms 26 and 27.

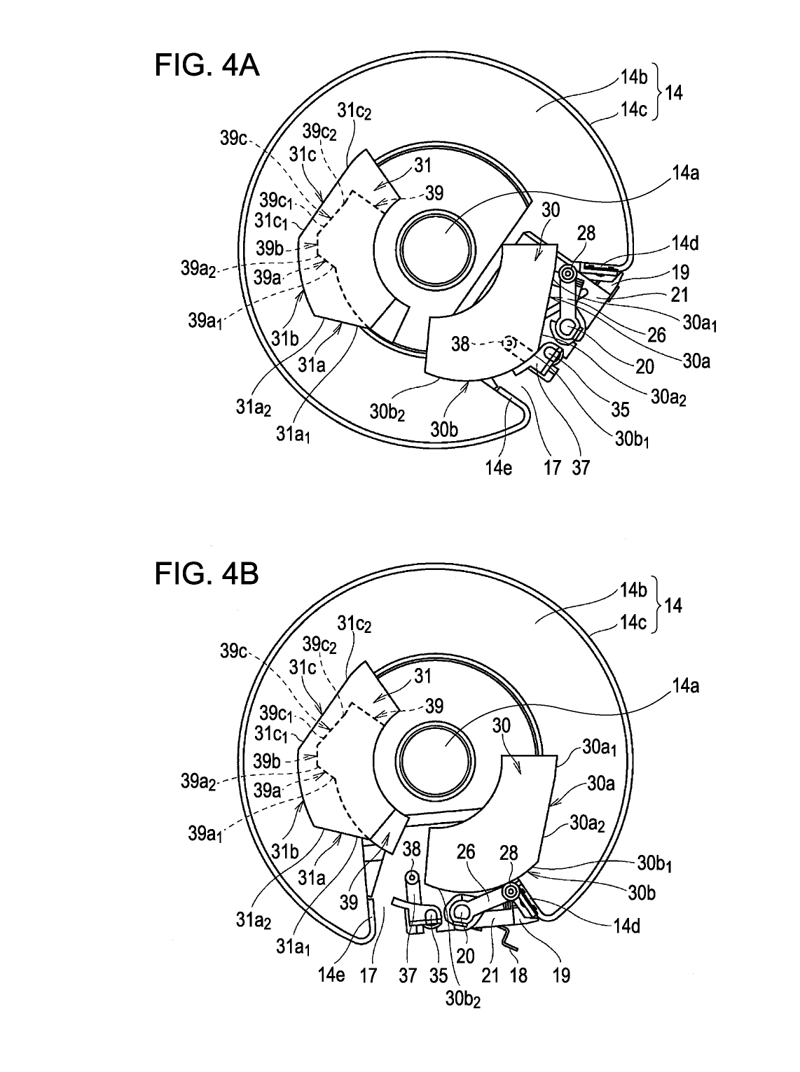

Furthermore, as shown in FIGS. 2A, 4A and 4B, in the second transfer portion 13, a first gripper control cam 30 is installed at one end of the second transfer roller 14. In addition, while it is not shown, a second gripper control cam is installed at the other end of the second transfer roller 14. The first gripper control cam 30 and the second gripper control cam are formed in the same shape and the same size and at the same time are arranged symmetrically to the straight line perpendicular to the center axis of the second transfer roller 14. In these first gripper control cam 30 and the second gripper control cam, as shown in FIG. 2C, each gripper 18 is supplied to the second transfer portion 13 at the time of second transfer. For example, each gripper 18 is controlled so that the front end 33a of the transfer material 33 such as a paper is gripped between with the gripper support member 19.

Furthermore, in the second transfer par 13, a third gripper control cam 31 is installed at one end of the second transfer roller 14. In addition, a fourth gripper control cam 32 is installed at the other end of the second transfer roller 14. These third and fourth gripper control cams 31 and 32 are always formed in the same shape and the same size and at the same time are arranged symmetrically to the straight line perpendicular to the center axis of the second transfer roller 14. The third and fourth gripper control cams 31 and 32 control each gripper 18 in such a manner that after the front end 33a of the transfer material 33 gripped by each gripper 18 have passed through the transfer nip, each gripper 18 releases the front end 33a of the transfer material 33. The first to fourth gripper control cams are, for example, fixed to the device main body and the like and at the same time constitute the control member of the one embodiment of the invention.

Furthermore, as shown in FIGS. 4A and 4B, the first gripper control cam 30 has a first gripper control cam surface 30a and a second gripper control cam surface 30b. In addition, the first gripper control cam follower 28 is controlled by coming in contact with the first and second gripper control cam surfaces 30a and 30b.

The cam profile of the first gripper control cam surface 30a is the profile that is formed in a straight line shape or nearly straight line shape. In that case, first gripper control cam surface 30a becomes successively more distant from the center of the rotation axis 14a of the second transfer roller 14, from a first contact starting portion 30a₁ in the start side to a first release position setting portion 30a₂ in the end side. At the time when the first gripper control cam follower 28 contacts the first contact starting portion 30a₁, the gripping portion 18b of the gripper 18 is set in the gripping position indicated by chain double-dashed line in FIG. 2C sitting on the gripper support member 19, and at the same time, at the time when the first gripper control cam follower 28 is situated at the final end of the first release position setting portion 30a₂, the gripping portion 18b of the gripper 18 is set in the release position indicated by the solid line in FIG. 2C separated from the gripper support member 19 to the maximum extent. Furthermore, the gripper 18 in the gripping position is indicated by the chain double-dashed line in FIG. 2C but is indicated by the solid line in FIGS. 2A and 2B. In addition, in a state in which the gripping portion 18b of the gripper 18 is set in the gripping position, when the first gripper control cam follower 28 approaches the first gripper control cam 30, the first gripper control cam follower 28 contacts the first contact starting portion 30a₁ of the first gripper control cam surface 30a.

Cam profile of the second gripper control cam surface 30b is the curved profile. In that case, the second gripper control cam surface 30b has a curved shape in which the curvature radius becomes gradually smaller from a first release position maintenance portion 30b₁ in the start side of the second gripper control cam surface 30b to the first gripping position setting portion 30b₂ in the end side of the second gripper control cam surface 30b. At the time when the first gripper control cam follower 28 is situated in the start end portion of the first release position maintenance portion 30b₁, the gripper 18 is maintained in the release position, and at the same time, at the time when the first gripper control cam follower 28 is situated at the final end of the first gripping position setting portion 30b₂, the gripper 18 is set in the gripping position.

While the detailed description is omitted, the other second gripper control cam is also formed exactly in the same manner as the first gripper control cam 30. Namely, the second gripper control cam also has the same third gripper control cam surface as the first gripper control cam surface 30a and at the same time has the same fourth gripper control cam surface as the second gripper control cam surface 30b. In addition, the second gripper control cam follower is controlled by coming in contact with the third and fourth gripper control cam surfaces.

On the other hand, the third and fourth gripper control cams 31 and 32 are formed in the same shape and the same size and at the same time are arranged symmetrically to the straight line perpendicular to the center axis of the second transfer roller 14.

As shown in FIGS. 4A and 4B, the third gripper control cam 31 has a fifth gripper control cam surface 31a, a first gripper release position maintenance cam surface 31b and a sixth gripper control cam surface 31c. In addition, the first gripper control cam follower 28 is controlled by coming in contact with the fifth gripper control cam surface 31a, the first gripper release position maintenance cam surface 31b and a sixth gripper control cam surface 31c.

Cam profile of the fifth gripper control cam surface 31a is the profile which is formed in a straight line shape or nearly a straight line shape. In that case, the fifth gripper control cam surface 31a becomes successively more distant from the center of the rotation axis 14a of the second transfer roller 14, from a second contact starting portion 31a₁ in the start side to a second release position setting portion 31a₂ in the end side. At the time when the first gripper control cam follower 28 contacts the second contact starting portion 31a₁, the gripper 18 is set in the gripping position, and at the same time, at the time when the first gripper control cam follower 28 is situated at the final end of the second release position setting portion 31a₂, the gripper 18 is set in the release position. In addition, in a state in which gripper 18 is set in the gripping position, when the first gripper control cam follower 28 approaches the third gripper control cam 31, the first gripper control cam follower 28 contacts the second contact starting portion 31a₁ of the fifth gripper control cam surface 31a.

Cam profile of the first gripper release position maintenance cam surface 31b is the profile formed in the arc that is concentric with the rotation axis 14a of the second transfer roller 14. When the first gripper control cam follower 28 is situated on the first gripper release position maintenance cam surface 31b, the gripping portion 18b of the gripper 18 is maintained in the release position set by the fifth gripper control cam surface 31a.

The cam profile of the sixth gripper control cam surface 31c is the profile that is formed in a straight line or nearly straight line shape. In that case, the sixth gripper control cam surface 31c successively approaches from the center of the rotation axis 14a of the second transfer roller 14, from a first gripper release position maintenance portion 31c₁ in the start side to a second gripping position setting portion 31c₂ in the end side. At the time when the first gripper control cam follower 28 is situated at the first gripper release position maintenance portion 31c₁, the gripper 18 is set in the release position, and at the same time, at the time when the first gripper control cam follower 28 is situated at the final end portion of the second gripping position setting portion 31c₂, the gripper 18 is set in the gripping position. In addition, in a state in which the gripper 18 is set in the gripping position, when the first gripper control cam follower 28 becomes more distant from the third gripper control cam 31, the first gripper control cam follower 28 is separated from the second gripping position setting portion 31c₂ of the sixth gripper control cam surface 31c.

While the detailed description will be omitted, the fourth gripper control cam 32 is also formed exactly in the same manner as the third gripper control cam 31. Namely, the fourth gripper control cam 32 has a seventh gripper control cam surface identical to the fifth gripper control cam surface 31a, a second gripper release position maintenance cam surface identical to the first gripper release position maintenance cam surface 31b, and an eighth gripper control cam surface identical to the sixth gripper control cam surface 31c. In addition, the second gripper control cam follower is controlled by coming in contact with the seventh gripper control cam surface, the second gripper release position maintenance cam surface and the eighth gripper control cam surface.

As shown in FIG. 2A, eight gripper support members 19 are arranged along the axial direction of the second transfer roller 14. Furthermore, the number of the gripper support member 19 is not limited to eight but can be installed corresponding to the number of the gripper 18. These gripper support members 19 are installed at the rear side wall 17a of the rear concave portion 17 in the rotation direction of the second transfer roller 14 of the concave portion 17. In that case, the overall gripper support members 19 are installed so that, in a state in which the gripping portion 18b of the gripper 18 grips the front end 33a of the transfer material 33 indicated by the chain double-dashed line in FIG. 2C, the overall grippers 18 are retreated further inwardly of the outline 14f of the rubber sheet 14c of the second transfer roller 14. Further, when the gripper 18 is in the release position indicated by the solid line in FIG. 2C, the gripping portion 18b of the gripper 18 is protruded further outwardly than the outline 14f of the rubber sheet 14c of the second transfer roller 14.

Furthermore, among the eight gripper support members 19, two gripper support members 19a positioned at both ends of the second transfer roller 14 are set in such a manner that the axial length of the second transfer roller 14 is larger than that of the other gripper support member 19. In addition, two grippers 18 each sit on these gripper support members 19a. As a result, it is configured so as to correspond to the size of the transfer material 33 in the axial direction of the second transfer roller 14. In that case, in this example, the gap between two grippers 18 that sits on these gripper support members 19a having the long length is smaller than that of the other grippers 18. Furthermore, the gripper support members 19a having long length can be each constituted by two gripper support members 19 that are identical to the other gripper support members 19. In this case, the gap between two gripper support members 19 is made smaller than that of the other gripper support members 19 corresponding to the narrow gap of two grippers 18.

Furthermore, in the concave portion 17, there is installed a protruding hook 34 as a transfer material peeling member being the second member of the embodiment of the invention. As shown in FIGS. 2A and 2B, nine protruding hooks 34 are arranged along the axial direction of the second transfer roller 14. Of course, the number of the protruding hooks 34 is not limited to nine but any number of the protruding hooks can be installed. Any one of the gripper support members 19 and 19a is arranged so as to be positioned between the adjoining protruding hooks 34. Each protruding hook 34 is formed in the same shape and the same size from the metallic thin band-like flat plate. While it is not shown, each protruding hook 34 is connected by a connecting portion and is formed in a comb shape.

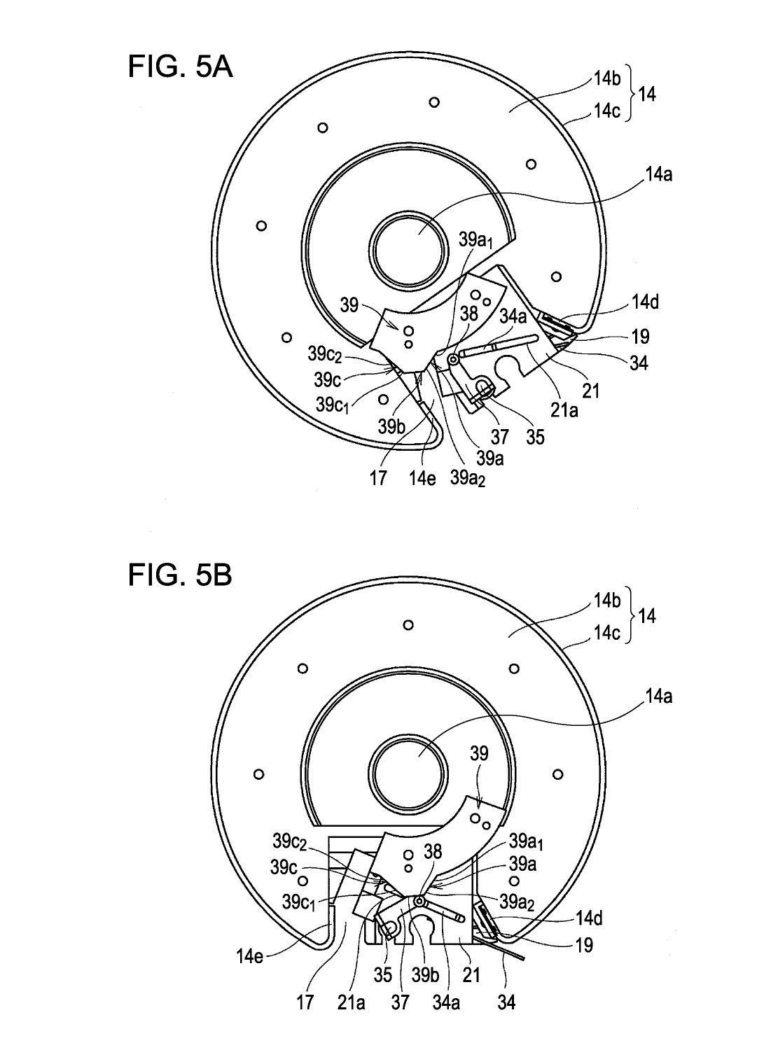

As shown in FIGS. 2A, 5A and 5B, straight line-shaped guide apertures 21a and 22a are installed at the support plate 21 and 22. In the guide apertures 21a and 22a, a guide portion 34a protruded from the one rim of the protruding hook 34 positioned at the most ends of the second transfer roller 14 is inserted so as to slide to the support plates 21 and 22. Thus, each protruding hook 34 is guided in the guide apertures 21a and 22a and integrally moves linearly.

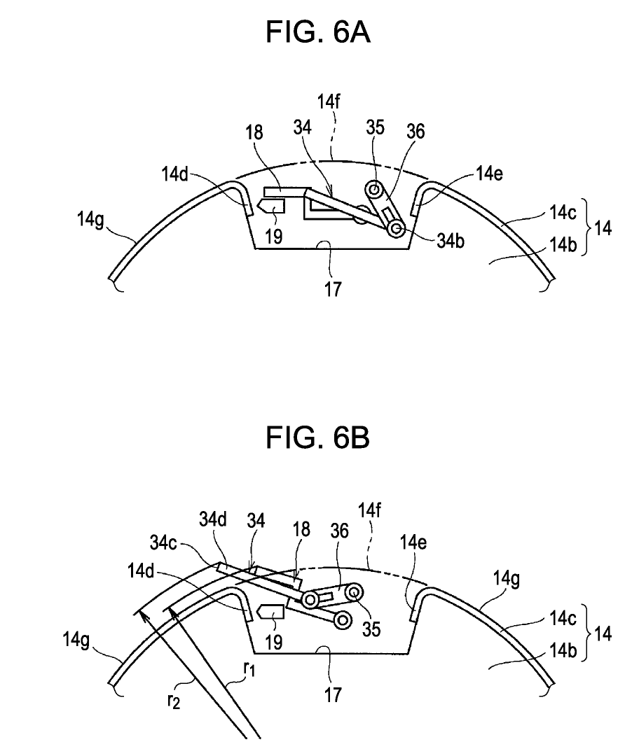

Furthermore, a rotation axis 35 is supported in the support plates 21 and 22 for relative rotation. As shown in FIGS. 6A and 6B, pressurization levers 36 are installed at both ends of the rotation axis 35 so as to be rotated integrally with the rotation axis 35. A connecting pin 34b installed at the connecting portion of each protruding hooks 34 is connected to the pressurization levers 36 so that when the connecting pin 34b rotates relative to the pressurization lever 36, the connecting pin moves along the pressurization lever 36 in a relatively linear fashion. In addition, each protruding hook 34 is movable between the retracted position shown in FIG. 6A and the protruding position shown in FIG. 6B. In that case, when each protruding hook 34 is positioned in the retracted position, the overall protruding hooks 34 are positioned inside of the outline 14f, that is to say, within the concave portion 17, and at the same time, when the protruding hooks 34 are positioned in the protruding position, the front end 34d including the protruding end 34c (corresponding to the contact portion of the embodiment of the invention) protrudes outward of the outline 14f, namely, outward from the concave portion 17.

Furthermore, when the protruding hooks 34 are in the retracted position, they do not contact the back surface of the transfer material 33, and at the same time, when they are in the protruding position, they contact the back surface of the transfer material 33 so as to protrude transfer material 33 from the outer peripheral surface 14g of the second transfer roller 14 (namely, peel the back surface of the transfer material 33 off the outer peripheral surface 14g of the second transfer roller 14).

Incidentally, the maximum protrusion amounts (namely, the maximum rotation radius r₂ of the protruding hook 34 around the rotation axis 14a shown in FIG. 6B) of the protruding hooks 34 protruded from the outline 14f when the protruding hooks 34 are in the protruding position is larger than the maximum protrusion amounts (namely, the maximum rotation radius r₁ of the grippers 18 around the rotation axis 14a shown in FIG. 6B) of the grippers 18 protruded from the outline 14f when the grippers 18 are in the release position (r₂>r₁). In this manner, the maximum protrusion amounts of the protruding hooks 34 is larger than the maximum protrusion amounts of the grippers 18, so that the transfer material 33 is effectively separated from the outer peripheral surface 14g of the second transfer roller 14.

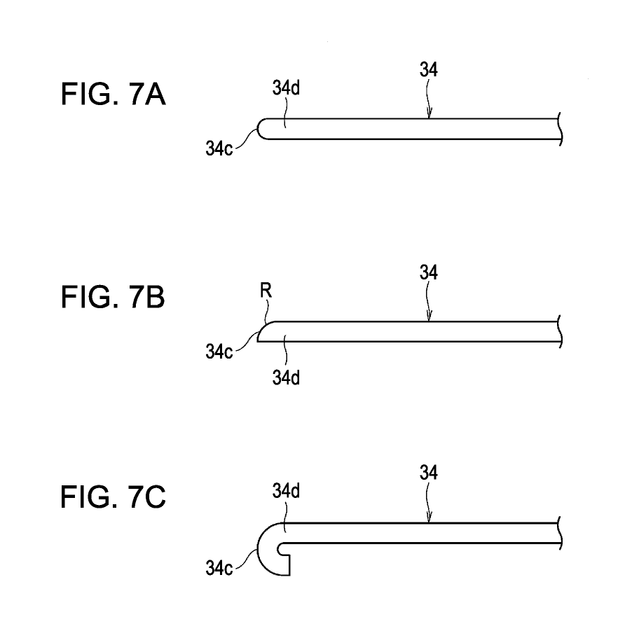

Furthermore, the protruding ends 34c of the protruding hooks 34 are formed in a curved shape. As one example, as shown in FIG. 7A, the protruding ends 34c of the protruding hooks 34 are formed in the arched shape. As another example, as shown in FIG. 7B, the edge portions of the protruding ends 34c of the protruding hooks 34 are formed in the round R portion. In addition, as another example, as shown in FIG. 7C, the front ends 34d of the protruding hooks 34 are bent in a U shape, so that the protruding ends 34c are in an arc shape. In this manner, the protruding ends 34c of the protruding hooks 34 are formed in a curved shape, so that the protruding ends 34c smoothly protrude the back surface of the transfer material 33, and at the same time, when the protruding ends 34c contact the middle transfer belt 8 for certain reason, suppress the damage of the middle transfer belt 8.

As shown in FIGS. 2A, 5A and 5B, each end of the rotation axis 35 passed through the support plates 21 and 22 passes through the transfer bearers 24 and 25 for relatively rotation. At the end of the rotation axis 35 passed through the transfer bearer 24, one end of the arm 37 is installed so as to be rotated integrally with the rotation axis 35. The arm 37 is always tensioned with a spring (not shown) in the direction (counterclockwise in FIGS. 5A and 5B) in which the protruding hook 34 is in the retracted position. At the other end of the arm 37, a roller-shaped first protruding hook control cam follower 38 is installed so as to be rotated relative to the arm 37. At the end of the rotation axis 35 passed through the transfer bearer 25, the same arm as the arm 37 is similarly installed so as to be rotated integrally with the rotation axis 35 and at the same time is always tensioned with the spring. In addition, at the other end of this arm, a second protruding hook control cam follower identical to the first protruding hook control cam follower 38 is installed so as to be rotated relative to the arm.

As shown in FIGS. 4A, 4B, 5A and 5B, in the second transfer portion 13, a first protruding hook control cam 39 is installed at one end of the second transfer roller 14. In addition, while it is not shown, a second protruding hook control cam follower is installed at the other end of the second transfer roller 14. In that case, the first protruding hook control cam 39 is arranged so as to be positioned between the transfer bearer 24 and the third gripper control cam 31 in the axial direction of the second transfer roller 14, and at the same time, the second protruding hook control cam is arranged so as to be positioned between the transfer bearer 25 and the fourth gripper control cam in the axial direction of the second transfer roller 14. The first protruding hook control cam 39 and second protruding hook control cam are, for example, fixed to the device main body and at the same time constitutes the control member of the embodiment of the invention.

The first protruding hook control cam 39 and the second protruding hook control cam are formed in the same shape and the same size and at the same time are arranged symmetrically to the straight line perpendicular to the center axis of the second transfer roller 14. These first protruding hook control cam 39 and the second protruding hook control cam control each protruding hook 34 so that when each gripper 18 releases the front end 33a of the transfer material 33 passed through the transfer nip of the second transfer portion 13, each protruding hook 34 protrudes the front end 33a of the transfer material 33 (peel the front end off the outer peripheral surface 14g of the second transfer roller 14).

As shown in FIGS. 5A and 5B, the first protruding hook control cam 39 has a first protruding hook control cam surface 39a, a first protruding hook protruding position maintenance cam surface 39b and a first protruding hook retreat control cam surface 39c. In addition, the first protruding hook control cam follower 38 is controlled by coming in contact with the first protruding hook control cam surface 39a, the first protruding hook protruding position maintenance cam surface 39b and the first protruding hook retreat control cam surface 39c.

The cam profile of the first protruding hook control cam surface 39a is the profile that is formed in a straight line shape or nearly straight line shape. In that case, the first protruding hook control cam surface 39a becomes successively more distant from the center of the rotation axis 14a of the second transfer roller 14, from a third contact starting portion 39a₁ in the start side to a first protruding position setting portion 39a₂ in the end side. At the time when the first protruding hook control cam follower 38 is positioned in the third contact starting portion 39a₁, the protruding hook 34 is set in the retracted position shown in FIG. 6A, and at the same time, at the time when the first protruding hook control cam follower 38 is positioned in the final end of the first protruding position setting portion 39a₂, the protruding hook 34 is set in the protruding position shown in FIG. 6B. Furthermore, when the first protruding hook control cam follower 38 approaches the first protruding hook control cam 39 in a state in which the protruding hook 34 is set in the retracted position, the first protruding hook control cam follower 38 comes in contact with the third contact starting portion 39a₁ of the first protruding hook control cam surface 39a.

Cam profile of the first protruding hook protruding position maintenance cam surface 39b is the profile which is formed in the arc concentric with the rotation axis 14a of the second transfer roller 14. When the first protruding hook control cam follower 38 is positioned in the first protruding hook protruding position maintenance cam surface 39b, the protruding hook 34 is maintained in the protruding position set by the first protruding hook control cam surface 39a.

Cam profile of the first protruding hook retreat control cam surface 39c is the profile formed in a straight line shape or nearly straight line shape. In that case, the first protruding hook control cam surface 39c approaches successively around the rotation axis 14a of the second transfer roller 14 from a first protruding position maintenance portion 39c₁ in the start side to a first retracted position setting portion 39c₂ in the end side. When the first protruding hook control cam follower 38 is positioned in the first protruding position maintenance portion 39c₁, the protruding hook 34 is maintained in the protruding position, and at the same time, when the first protruding hook control cam follower 38 is positioned in the first retracted position setting portion 39c₂, the protruding hook 34 is set in the retracted position.

While the description is omitted, the second protruding hook control cam is also formed exactly in the same manner as the first protruding hook control cam 39. Namely, the second protruding hook control cam has a second protruding hook control cams surface identical to the first protruding hook control cam surface 39a, a second protruding hook protruding position maintenance cam surface identical to the first protruding hook protruding position maintenance cam surface 39b and a second protruding hook retreat control cam surface identical to the first protruding hook retreat control cam surface 39c. Furthermore, the second protruding hook control cam follower is controlled by coming in contact with the second protruding hook control cams surface, the second protruding hook protruding position maintenance cam surface and the second protruding hook retreat control cam surface.

The second transfer roller cleaning portion 15 removes foreign substance such as liquid developer attached to the rubber sheet 14c of the second transfer roller 14 with the cleaning member such as a cleaning blade.

As shown in FIG. 1, the image forming device 1 includes a gate roller 40 and a transfer material supply guide 41 that supply the second transfer portion 13 with the transfer material 33. Similar to the gate roller of related art, the gate roller 40 provides the transfer material 33 to the second transfer portion 13 in synchronous with the toner image transported by the middle transfer belt 8. In addition, the transfer material supply guide 41 guides the transfer material 33, which is provided by the gate roller 40, so as to securely provide it to the second transfer portion 13.

Furthermore, the image forming device 1 includes an airflow generating device 42 having an air fan or the like. This airflow generating device 42 is arranged at the adjoining position facing the each rotation direction β and δ of the middle transfer belt 8 and the second transfer roller 14 further than the transfer nip between the middle transfer belt 8 and the second transfer roller 14. In addition, the airflow generating device 42 jets air from an ventilation member 42a toward the front end 33a of the transfer material 33 which has been released from the gripping of the gripper 18 in the direction 8. As a result, the front end 33a of the transfer 33 is prevented from being interlocked with the middle transfer belt 8 to the winding roller 10 and the middle transfer belt tension roller 11. In particular, with regard to the delicate transfer material 33 such a thin paper, the interlock of the transfer material 33 with the middle transfer belt 8 is effectively prevented.

Furthermore, the image forming device 1 includes an after-transferring transfer material guide 43, a transfer material back surface transport portion 44, an after-fixing transfer material guide 45 and a fixing portion 46. The after-transferring transfer material guide 43 is arranged in the adjoining position that faces the rotation direction δ of the second transfer roller 14 rather than the ventilation member 42a of the airflow generating device 42. This after-transferring transfer material guide 43 has an adsorption member 43a and an airflow generating device 43b such as an air fan. A plurality of air circulation apertures (transfer material adsorption apertures) are installed on a guide surface 43a₁ of the adsorption member 43a. This adsorption member 43a draws the transfer material 33, which has been transported, to the guide surface 43a₁ by means of the air adsorption in the direction ζ by the airflow generating device 43b, and the transfer material 33 is guided by the guide surface 43a₁ and transported.

Transfer material back surface transport portion 44 is arranged in the adjoining position that faces the movement direction of the transfer material 33 than the after-transferring transfer material guide 43. This transfer material back surface transport portion 44 has a transfer material transport member 44a such as an endless-shaped transfer material back surface transport belt having a plurality of air circulation apertures (transfer material adsorption apertures), transfer material transport member guide 44b and an adsorption member 44c such as an air fan. The transfer material transport member 44a is wound around a transfer material transport member drive roller 44d, a transfer material transport member carrying roller 44e, and a transfer material transport member carrying belt 44d. In that case, the transfer material transport member 44a is provided with tension by the transfer material transport member carrying roller 44e and at the same time rotates in the arrow δ direction (clockwise in FIG. 1) by means of the transfer material transport member drive roller 44d. The transfer material back surface transport portion 44 performs back surface-transport of the transfer material 33 toward the before-fixing transfer material guide 45 by the rotation of the transfer material transport member 44a (namely, brings the surface opposite to the toner image transfer surface of the transfer material 33 in contact with the transfer material transport member 44a to transport the transfer material 33), while drawing the back surface side of the transfer material 33 that has been guided by the transfer material transport member 44a to the transfer material transport member 44a by the air adsorption in the direction η due to the adsorption member 44c.

The before-fixing transfer material guide 45 is arranged in the adjoining position that faces the movement direction of the transfer material 33 than the transfer material back surface transport portion 44. The before-fixing transfer material guide 45 has a guide member 45a and an airflow generating device 45b such as an air fan. While it is not shown, on a guide surface 45a₁ of the guide member 45a, a plurality of air circulation apertures (transfer material adsorption apertures) are installed. This guide member 45a draws the transfer material 33 that has been back surface-transported by the transfer material transport member 44a to the guide surface 45a₁ by the air adsorption in direction θ due to the airflow generating device 45b and guides the transfer material 33 to the fixing portion 46.

The fixing portion 46 is the fixer of related art having, for example, a heating roller 46a and a pressurization roller 46b. The toner image of the transfer material 33 is heated and pressurized, and fixed by the fixing portion 46.

Furthermore, while it is not shown, similar to the image forming device of related art that performs second transfer, the image forming device 1 of this example includes a transfer material receiving device, which receives the transfer material at the further front side in the transfer material transport direction than the gate roller 40, and at the same time has a discharge transfer material tray facing the transfer material transport direction than the fixing portion 46.

Image forming operation of by the image forming device 1 of this example will be described.

Similar to the image forming device of related art in which liquid developer is used and each photosensitive body is arranged in tandem, by means of image forming operation start, each photosensitive body 2Y, 2M, 2C and 2K is regularly electrified by each electrification portion 3Y, 3M, 3C and 3K. Thereafter, electrostatic latent images are written on each photosensitive body 2Y, 2M, 2C and 2K by each light exposure portion 4Y, 4M, 4C and 4K (first to fourth writing processes). Then, by means of each development portion 5Y, 5M, 5C and 5K, electrostatic latent images of each photosensitive body 2Y, 2M, 2C and 2K are developed by the liquid developer, whereby toner images are formed (first to fourth development processed).

Toner images of each photosensitive body 2Y, 2M, 2C and 2K are transferred to the middle transfer belt 8 by each of the first transfer portions 6Y, 6M, 6C and 6K (first transfer process). In that case, in the example shown in FIG. 1, in the order of yellow, magenta, cyan and black, colors-overlap and transfer are performed. In this way, full-color toner images are carried on the middle transfer belt 8. Successively, the toner images carried on the middle transfer belt 8 are transferred to the transfer material 33, which has been transported from the gate roller 40, by means of the second transfer portion 13.

Transfer of the toner images to the transfer material 33 in this second transfer portion 13 will be described in more detail.

When the middle transfer belt 8 starts to rotate, the second transfer roller 14 also rotates. At this time, the first gripper control cam follower 28 is positioned before it passes the second gripping position setting portion 31c₂ of the third gripper control cam 31 and approaches the first contact start portion 30a₁ of the first gripper control cam 30. The second gripper control cam follower 29 is also identical thereto. In this position of the first and second gripper control cam followers 28 and 29, the first gripper control cam follower 28 is not controlled by the first and third gripper control cams 30 and 31, and at the same time, the second gripper control cam follower 29 is not controlled by the second gripper control cam and the fourth gripper control cam 32. Thus, the gripping portion 18b of the gripper 18 sits on the gripper support member 19.

Furthermore, the first protruding hook control cam follower 38 and the second protruding hook control cam follower are in the position adjacent to the first gripper control cam follower 28 and the second gripper control cam follower and do not contact the first protruding hook control cam 39 and the second protruding hook control cam. In this position of the first and second protruding hook control cam followers, the first protruding hook control cam follower 38 is not controlled by the first protruding hook control cam 39 and at the same time the second gripper control cam follower is not controlled by the second protruding hook control cam. Thus, the protruding hook 34 is set in the retracted position.

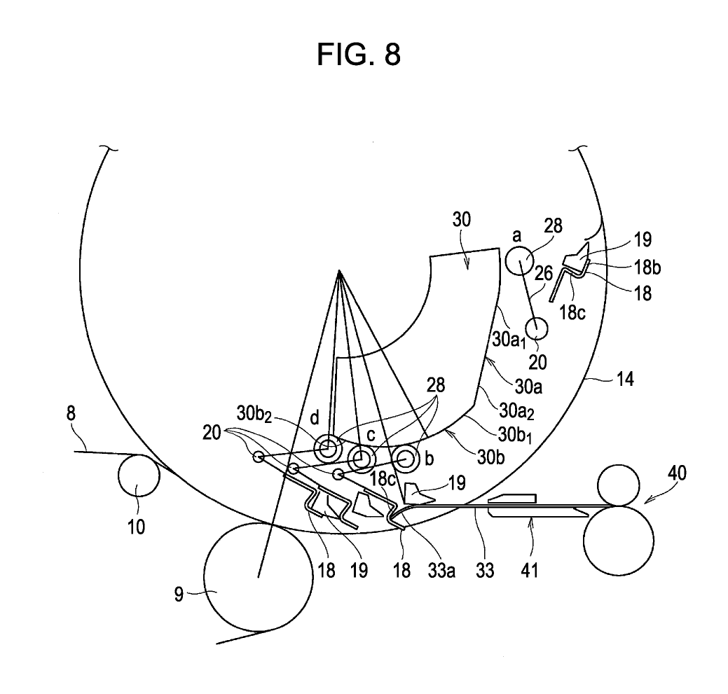

As the toner image carried in the middle transfer belt 8 approaches the second transfer portion 13, as shown in FIG. 8, the first gripper control cam follower 28 reaches the position (a) that approaches the first contact starting portion 30a₁ of the first gripper control cam 30. The second gripper control cam follower 29 is also identical thereto. Furthermore, the second transfer roller 14 rotates, so that the first gripper control cam follower 28 contacts the first contact starting portion 30a₁. The second gripper control cam follower 29 is also identical thereto. As a consequence of further rotation of the second transfer roller 14, the first gripper control cam follower 28 is controlled in the direction separated from the center of the rotation axis 14a of the second transfer roller 14 by the first gripper control cam surface 30a. The second gripper control cam follower is also identical thereto. Thereupon, the first and second arms 26 and 27 rotate, and each gripper 18 starts to separate from the gripper support member 19. When the first and second gripper control cam followers 28 and 29 approach the first and second release position setting portions of the first and second gripper control cam surfaces, the gripper 18 is in the release position.

The gripper 18 set in the release position approaches the supply position of the transfer material 33 from the gate roller 40 by rotation of the second transfer roller 14. On the other hand, the transfer material 33 from the gate roller 40 is supplied to the second transfer roller 14, and at the same time the toner image carried on the middle transfer belt 8 approaches the second transfer portion 13. The rotation of the middle transfer belt 8, the rotation of the second transfer roller 14 and the rotation of the gate roller 40 are synchronously controlled so that the toner image of the middle transfer belt 8 is transferred to the predetermined position of the transfer material in the transfer nip portion. At this time, the circumferential speed of the second transfer roller 14 (namely, movement speed of the gripper 18) is lower than the movement speed of the transfer material 33 transported from the gate roller 40. Thus, the front end of the transfer material 33 enters between the gripper 18 and the gripper support member 19 to contact the step portion 18c of the gripper 18. In addition, when the first and second gripper control cam followers 28 and 29 reach the position (b), due to the speed difference between the circumferential speed of the second transfer roller 14 and the movement speed of the transfer material 33, the front end of the transfer material 33 contacts the corner portion of the step portion 18c and is positioned relative to the gripper 18, and at the same time the front end 33a of the transfer material 33 gets bent.

Until the first and second gripper control cam followers 28 and 29 reach the position (c), a portion of the transfer material 33 contacts the outer periphery surface of the second transfer roller 14 and at the same time is curved along the outer periphery surface. When the first and second gripper control cam followers 28 and 29 reach the first and second gripping position setting portions of the first and second gripper control cam surfaces, the first and second arms 26 and 27 rotate in the direction opposite to the above described direction, and each gripper 18 starts to approach the gripper support member 19. In addition, at the time when the first and second gripper control cam followers 28 and 29 reach the final end positions (d) of the first and second gripping position setting portions, each gripper 18 pressurizes and grips the front end 33a of the transfer material 33 to the gripper support member 19 (transfer material gripping process). In this manner, the transfer material 33 is positioned relative to the second transfer roller 14 and at the same time securely moves to the transfer nip simultaneously with rotation of the second transfer roller 14, while being gripped by the gripper 18. At this time, the first and second gripper control cam followers 28 and 29 are separated from the first and second gripper control cams. In addition, meanwhile, the first and second protruding hook control cam followers do not contact the first and second protruding hook control cams, so that the protruding hook 34 is maintained at the retracted position.

The toner image of the middle transfer belt 8 is transferred to the transfer material 33 in the transfer nip. When the gripping portion of the front end 33a of the transfer material 33 by the gripper 18 passes through the transfer nip, the first and second gripper control cam followers 28 and 29 approach the third and fourth gripper control cams 31 and 32 and contact the third and fourth gripper control cam surfaces. As a consequence of further rotation of the second transfer roller 14, the first and second gripper control cam followers 28 and 29 are guided in the direction that becomes more distant from the center of the rotation axis 14a of the second transfer roller 14. Thereupon, the gripper 18 starts to move in the direction separated from the gripper support member 19, and the front end 33a of the transfer material 33 starts to be released. Continuously, the first and second protruding hook control cam followers approach the first and second protruding hook control cams and contact the first and second protruding hook control cam surfaces. As a consequence of further rotation of the second transfer roller 14, the first and second protruding hook control cam followers are guided in the direction that becomes more distant from the center of the rotation axis 14a of the second transfer roller 14.

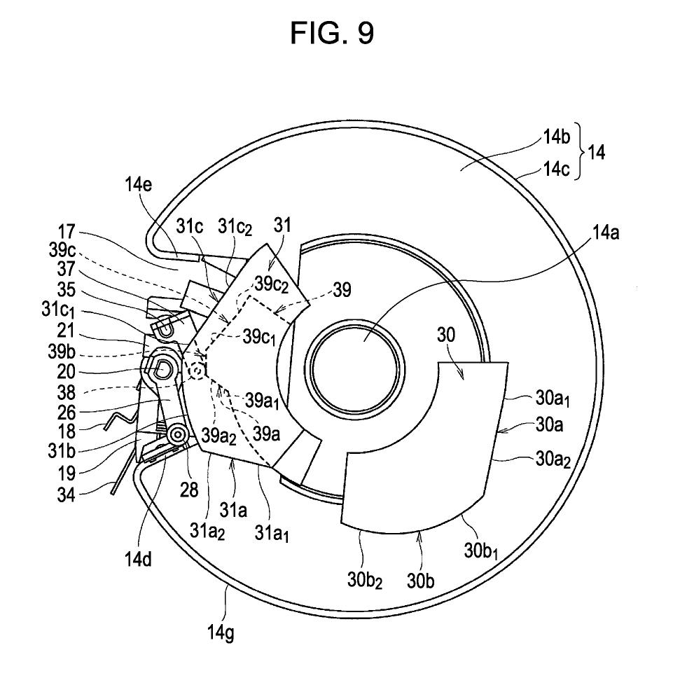

As a consequence of further rotation of the second transfer roller 14, the gripper 18 is set in the release position, and at the same time, as shown in FIG. 9, the first and second gripper control cam followers 28 and 29 contact the first and second gripper release position maintenance cam surfaces of the third and fourth gripper control cams 31 and 32, so that the gripper 18 is maintained in the release position. Continuously, the protruding hook 34 is set in the protruding position, and at the same time, as shown in FIG. 9, the first and second protruding hook control cam followers contact the first and second protruding hook protruding position maintenance cam surfaces so that the protruding hook 34 is maintained in the protruding position.

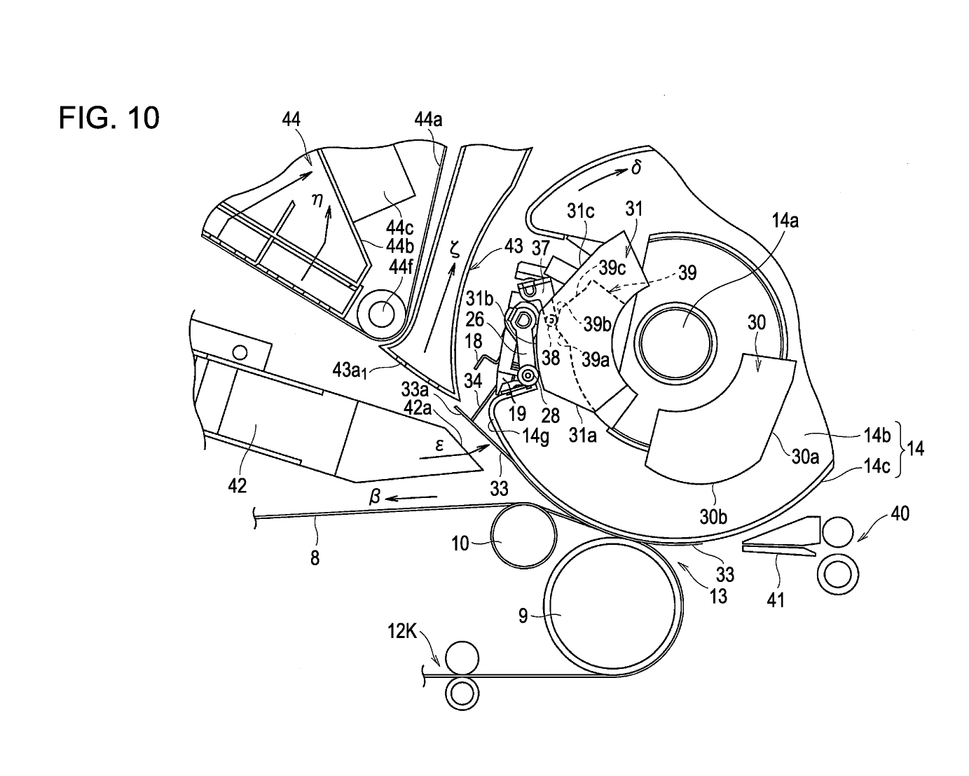

On the other hand, the front end 33a of the transfer material 33, which has been released from the gripping by the gripper 18, can be lightly pressurized to the second transfer roller 14 by means of air jet from the airflow generating device 42 as shown in FIG. 10 and at the same time can be pressurized by the protruding hook 34 in the direction separated from the outer periphery surface 14g of the second transfer roller 14. In this way, the front end 33a of the transfer material 33 is leaded to the adsorption member 43a of the after-transferring transfer material guide 43. The transfer material 33 pinched in the nip portion of the middle transfer belt 8 and the second transfer roller 14 moves to the adsorption member 43a by further rotation of the middle transfer belt 8 and the second transfer roller 14. Namely, the transfer end portion of the transfer material 33 is peeled off, while the toner image of the middle transfer belt 8 is second transferred to the transfer material 33 (transfer material peeling process). In addition, in case of the transfer material 33 with small elastic recovery and having weak waist, air jet of the airflow generating device 42 can be omitted.

The transfer material 33 moved to the adsorption member 43a is drawn and guided to the guide surface 43a₁ of the adsorption member 43a by means of air adsorption of the airflow generating device 43b and moves to the transfer material back surface transport portion 44. Thereupon, the back surface of the front end 33a of the transfer material 33 contacts the transfer material transport member 44a and at the same time moves together with the transfer material transport member 44a. In addition, when the transfer material 33 reaches the transfer material transport member guide 44b, the transfer material 33 is drawn to the transfer material transport member 44a by the air adsorption of the transfer material transport member guide 44b and back surface-transported by the transfer material transport member 44a.

When the front end 33a of the transfer material 33 passes through the transfer material transport member guide 44b, the front end 33a is not drawn by the transfer material transport member guide 44b and becomes the state that is easy to be separated from the transfer material transport member 44a. When the front end 33a of the transfer material 33 passes through near the transfer material transport member drive roller 44d, the transfer material 33 is leaded to the guide member 45a. The transfer material 33 leaded to the guide member 45a is drawn and guided to the guide surface 45a₁ of the guide member 45a by air adsorption of the airflow generating device 45b and moves to the fixing portion 46.

The toner image of the transfer material 33 which has been moved to the fixing portion 46 is heated and pressurized in the same manner as the fixing portion of related art and is fixed to the transfer material 33. After fixing, the transfer material 33 is transported to a discharge transfer material tray and is accommodated therein. In this way, the image forming process is completed.

According to the image forming device 1 of this example, while the front end 33a of the transfer material 33 is gripped by means of the transfer material 33, the third image of the liquid developer, which has been transferred to the middle transfer belt 8, is transferred to the transfer material 33. Thus, after transfer, it is possible to more securely peel the transfer material 33 off the middle transfer belt 8.

Furthermore, overall the grippers 18 in the gripping position of the transfer material 33 and overall the protruding hooks 34 in the retracted position are positioned inside of the outline 14f of the second transfer roller 14 in the concave portion 17. Thus, when the grippers 18 and the protruding hooks 34 pass through the transfer nip of the middle transfer belt 8 and the second transfer roller 14, the scattering of each rotation of the middle transfer belt 8 and the second transfer roller 14 can be suppressed, and at the same time the fluctuations in pressure-contact force of the middle transfer belt 8 and the second transfer roller 14 can be suppressed. Thus, bending hardly occurs and excellent image forming can be performed. In addition, it is possible to suppress damage to the middle transfer belt 8 caused by the grippers 18 and the protruding hooks 34. As a result, even if the grippers 18 and the protruding hooks 34 are installed at the second transfer roller 14, it is possible to improve the durability of the middle transfer belt 8.

Furthermore, transfer to the transfer material 33 is performed while gripping the front end 33a of the transfer material 33 by the gripper 18, and at the same time, at the time of gripping release of the front end 33a of the transfer material 33 by the gripper 18, the transfer material 33 is separated from the middle transfer roller 8 by means of the protruding hook 34. In this way, by using two grippers 18 with different functions and protruding hooks 34, it is possible to securely peel the transfer material 33 off the middle transfer belt 8, and at the same time it is possible to satisfactorily transport the transfer material 33 from the middle transfer roller 8 to the after-transferring transfer material guide 43 being the next processing portion.

Furthermore, the rotation radius r₂ of the protruding hook 34 around the rotation axis of the middle transfer roller 8 at the time of separation from the middle transfer roller 8 of the transfer material 33 is made larger than the rotation radius r₁ of the gripper 18 around the rotation axis of the middle transfer roller 8 at the time of gripping release of the front end 33a of the transfer material 33. As a result, the transfer material 33 after gripping release can be more satisfactorily transported to the next after-transferring transfer material guide 43.

In that case, by forming the gripper 18 independently from the protruding hook 34, it is possible to separate the gripper 18 from the protruding hook 34, thereby flexibly controlling them with corresponding cam.

Furthermore, by fixing the image of the transfer material 33 after transfer with the fixing portion, even if the gripping portion of the transfer material is slightly collapsed by the gripper 18, it is possible to correct the collapse of the transfer material 33 to some extent by the heating and the pressurization of the fixing portion 46. In addition, the transfer material 33 is peeled off the middle transfer belt 8, wile transferring the image of the middle transfer belt 8 to the transfer material 33. The image forming time can hereby be reduced.

Furthermore, after-transferring transfer material guide 43 is disposed at the adjoining position of the final end of the transfer nip, and at the same time the transfer material back surface transfer portion 44 and before fixing transfer material guide 45 are installed adjacent to the after-transferring transfer material guide 43. As a result, the image forming device can be made to be small and compact.

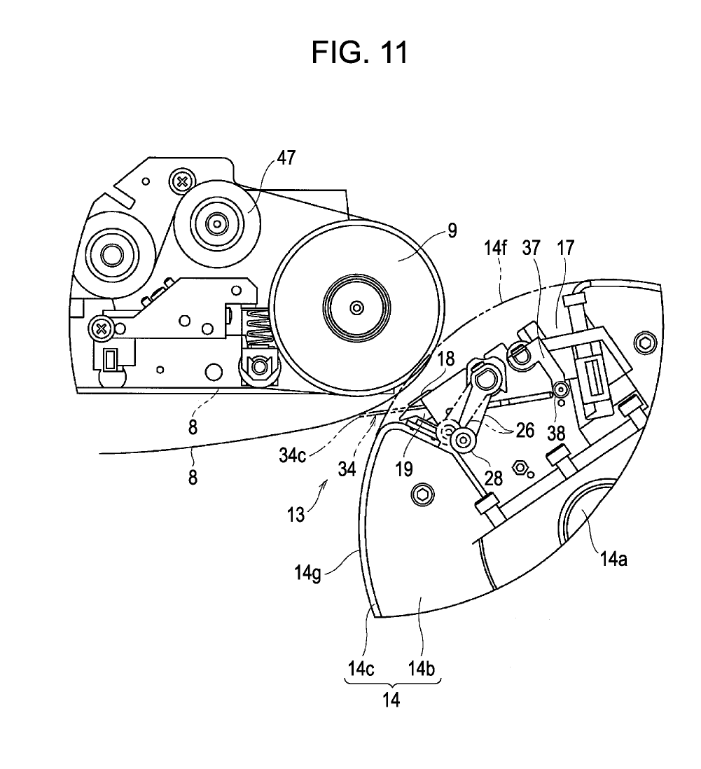

FIG. 11 is a partly enlarged view that partly shows another example of the embodiment of the image forming device of the invention.

In the image forming device 1 of the example shown in FIG. 1, the second transfer roller 14 is disposed at the winding end side of the middle transfer belt 8 to the middle transfer belt drive roller 9. In this regard, in the image forming device 1 of this example, as shown in FIG. 11, the second transfer roller 14 is disposed at the winding start side of the middle transfer belt drive roller 9 of the middle transfer belt 8. Namely, in the image forming device 1 of this example, the rotation center of the second transfer roller 14 is positioned at the lower side of the rotation center of the middle transfer belt drive roller 9.

In addition, in the image forming device 1 of this example, while the winding roller 10 of the above-described example is not installed, there is installed a driven roller 47 around which the middle transfer belt 8 is simply wound. Thus, the transfer nip of the second transfer roller 14 and the middle transfer belt 8 is a pressurization nip in which the second transfer roller 14 pressurizes the middle transfer belt 8 to the middle transfer belt drive roller 9.

Another configuration of the image forming device 1 of this example is identical to that of the above-described example. In that case, the middle transfer belt 8 is stretched by the middle transfer belt tension roller 11 as indicated by chain double-dashed line in FIG. 11, and at the same time, at the time of stretch release, is bent downward as indicated by solid line in FIG. 11. In addition, in a state in which, as indicated by the chain double-dashed line in FIG. 11, the protruding hook 34 is situated at the protruding position and the protruding end 34c of the protruding hook 34 is in contact with the middle transfer belt 8 bent downward, the second transfer roller 14 is stopped. In this case, the protruding end 34c of the protruding hook 34 is curved as shown in FIG. 7A or 7C, so that damage of the middle transfer belt 8 caused by the protruding hook 34 is suppressed.

Furthermore, while it is not shown in FIG. 11, also in this example, the airflow generating device 42 is disposed at the adjoining position that faces each rotation direction β and δ of the middle transfer belt 8 and the second transfer roller 14 rather than the transfer nip of the middle transfer belt 8 and the second transfer roller 14, and the after-transferring transfer material guide 43 is disposed at the adjoining position that faces the rotation directions 6 of the second transfer roller 14 rather than the ventilation member 42a of the airflow generating device 42. Furthermore, the transfer material back surface transport portion 44, the before fixing transfer guide 45 and the fixing portion 46 are suitably arranged with respect to the after-transferring transfer material guide 43.

Other working effects of the image forming device 1 of this example are identical to those of the above-describe example.

In addition, while the image forming device and the image forming method of the invention are not limited to each example of the above described embodiments and, for example, in the above-described each embodiment, the gripper 18 is formed independently from the protruding hook 34, the gripper 18 and the protruding hook 34 may be formed integrally. In this case, the first and second protruding hook control cams are omitted, and at the same time the protruding hook 34 and the gripper 18 are operation-controlled simultaneously by the third and fourth gripper control cams 31 and 32. Thus, the structures of the control cams of the gripper 18 and the protruding hook 34 and controls of the gripper 18 and the protruding hook 34 become simple. In short, various design changes can be made within the scope of the matters described in the claims. The entire disclosure of Japanese Patent Application No: 2009-14040, filed Jan. 26, 2009 is expressly incorporated by reference herein.

What is claimed is:

1. An image forming device comprising:
a first image carrier;
a first development unit that develops the first image carrier with a first liquid developer;
a second image carrier;
a second development unit that develops the second image carrier with a second liquid developer;
a transfer belt to which images developed on the first image carrier and the second image carrier are transferred; and
a transfer roller that has a transfer material gripping member for gripping a transfer material, is brought into pressure contact with the transfer belt and is applied with a transfer bias so as to transfer the images which have been transferred to the transfer belt to the transfer material;
wherein the transfer material gripping member is positioned inside of the outer periphery surface of the transfer roller so as to grip the transfer material.

2. The image forming device according to claim 1,
wherein the transfer material gripping member has a first member that grips a front end of the transfer material in a movement direction of the transfer material and a second member that separates the transfer material from the transfer roller when gripping of the transfer material by the first member is released.

3. The image forming device according to claim 2,
wherein the first member and the second member are integrally constituted.

4. The image forming device according to claim 2, further comprising:
a belt tension release unit for releasing tension of the transfer belt,
wherein contact portion of the second member with the transfer material is a round shape.

5. The image forming device according to claim 1, further comprising:
a fixing portion that fixes the images transferred to the transfer material.

6. An image forming method comprising:
first writing process of writing a first latent image on a first image carrier;
first development process of developing the first latent image with a first liquid developer to form a first image;
second writing process of writing a second latent image on a second image carrier;
second development process of developing the second latent image with a second liquid developer to form a second image;
first transferring process of transferring the first and second images to a transfer belt;
transfer material gripping process of gripping a transfer material by a transfer material gripping member arranged inside of an outer periphery surface of a transfer roller;
transferring process of transporting the transfer material gripped in the transfer roller by the transfer material gripping member to a transfer nip portion formed by the transfer belt and the transfer roller so as to transfer the image transferred to the transfer belt to the transfer material; and
transfer material peeling process of gripping the transfer material, which has passed through the transfer nip portion and to which the image has been transferred, by the transfer material gripping member so as to peel the transfer material off the transfer belt.
